(19) United States
(12) Patent Application Publication
(10) Pub. No.: US 2022/0063569 A1
(43) Pub. Date: Mar. 3, 2022

(54) WET SEAT DETECTION

(71) Applicant: Ford Global Technologies, LLC, Dearborn, MI (US)

(72) Inventors: David Michael Herman, Oak Park, MI (US); Aaron Lesky, Ypsilanti, MI (US); Ronald Beras, Warren, MI (US); Nathaniel Martin Pressel, Waterford, MI (US)

(73) Assignee: Ford Global Technologies, LLC, Dearborn, MI (US)

(21) Appl. No.: 17/004,278

(22) Filed: Aug. 27, 2020

(51) Int. Cl. B60S 1/64; B60N 2/00; B60N 2/56; B60N 2/90; B60R 11/04

(52) U.S. Cl. CPC B60S 1/64; B60N 2/002; B60R 2300/8006; B60N 2/90; B60R 11/04; B60N 2/5678

(57) ABSTRACT

A system comprises a processor and a memory. The memory stores instructions executable by the processor to determine a baseline polarization for a surface of a material based on a first polarimetric image of the surface, to determine a second polarization for the surface based on a second polarimetric image of the surface, to determine, based on the baseline polarization data and the second polarization data, that there is a wet area on the surface, and upon determining the wet area, actuate an actuator to cause a clean the surface.

### BACKGROUND

A surface, e.g., a vehicle seat, may become wet. For example, spilling a drink or other liquid on a seat surface may cause the surface to become wet. Liquid that pools on and/or soaks into a surface such as a seat surface can damage the surface and/or render it unusable, at least temporarily. However, wet surfaces can be difficult to detect.

### BRIEF DESCRIPTION OF THE DRAWINGS

FIG. 1 shows a vehicle with one or more polarimetric camera sensors.

FIG. 2 is a diagram illustrating an example camera sensor of FIG. 1.

FIG. 3A illustrates a baseline polarimetric image of a surface.

FIG. 3B illustrates a second polarimetric image of the surface of FIG. 3A.

FIG. 3C illustrates a difference of the polarimetric images of FIGS. 3A and 3B.

FIGS. 4A-4B is a flowchart of an exemplary process for detecting a wet surface.

### DETAILED DESCRIPTION

### Introduction

Disclosed herein is a system, comprising a processor and a memory. The memory stores instructions executable by the processor to determine a baseline polarization for a surface of a material based on a first polarimetric image of the surface, to determine a second polarization for the surface based on a second polarimetric image of the surface, to determine, based on the baseline polarization data and the second polarization data, that there is a wet area on the surface, and to upon determining the wet area, actuate an actuator to cause a clean the surface.

The baseline polarization may include a baseline degree of polarization and a baseline angle of polarization, and the second polarization may include a second degree of polarization and a second angle of polarization.

The instructions may further include instructions to identify the wet area as an area for which a change of angle of polarization for a plurality of pixels exceeds an angle threshold.

The instructions may further include instructions to identify the wet area further as an area for which a degree of polarization exceeds a degree of polarization threshold.

The instructions may further include instructions to determine the baseline polarization of a plurality of pixels of the first polarimetric image, and to determine the second polarization for a plurality of pixels of the second polarimetric image.

The material may be in a vehicle interior, and the instructions may further include instructions to capture the first polarimetric image upon determining, based on received sensor data, that a light intensity in the vehicle interior exceeds a threshold.

The instructions may further include instructions to actuate a light in the vehicle interior upon determining that the light intensity in the vehicle interior is less than the threshold, and capture the first polarimetric image after actuation of the interior light.

The material may be on a vehicle seat, and the instructions may further include instructions to capture the second polarimetric image upon determining based at least in part on vehicle door sensor data that the vehicle seat is unoccupied.

The instructions may further include instructions to determine a type of the material of a vehicle seat upholstery and to identify the presumed wet area further based on the determined material.

The material may be on a vehicle seat, and the instructions may further include instructions to estimate a first threshold for a rate of change of a degree of polarization from a time of a spill and a second threshold for a rate of change of an angle of polarization, based on the determined material of the seat, to capture a plurality of second polarimetric images upon determining that the vehicle seat is unoccupied, to determine the rate of change of the degree of polarization and the rate of change of the angle of polarization based on the captured plurality of second polarimetric images, and to identify the wet area further based on (i) the determined rate of change of the degree of polarization, (ii) the determined rate of change of the angle of polarization, (iii) the first threshold, and (iv) the second threshold.

The instructions may further include instructions to determine the type of the material based on an output of a trained neural network.

The material may be on a vehicle seat, and the instructions to actuate the actuator may include an instruction to actuate a seat heater, output a warning, or navigate the vehicle to a specified location for service.

The instructions may further include instructions to, upon determining that the surface position in the second polarimetric image is changed with respect to the first polarimetric image, adjust the second polarimetric image using a template matching technique.

The material may be on a vehicle seat, and the instructions may further include instructions to detect a change in a position of the seat, adjust the second polarimetric image based on the detected change in the position of the seat, and determine whether the seat is wet based at least in part on the adjusted second polarimetric image.

The instructions may further include instruction to actuate a second actuator to restrict an access to the surface upon determining the wet area.

Further disclosed herein is a method, comprising determining a baseline polarization for a surface of a material based on a first polarimetric image of the surface, determining a second polarization for the surface based on a second polarimetric image of the surface, determining, based on the baseline polarization data and the second polarization data, that there is a wet area on the surface, and upon determining the wet area, actuating an actuator to cause a clean the surface.

The baseline polarization may include a baseline degree of polarization and a baseline angle of polarization, and the second polarization may include a second degree of polarization and a second angle of polarization.

The method may further include identifying the wet area as (i) an area for which a change of angle of polarization for a plurality of pixels exceeds an angle threshold or (ii) an area for which a degree of polarization exceeds a degree of polarization threshold.

The method may further include determining the baseline polarization of a plurality of pixels of the first polarimetric image, and determining the second polarization for a plurality of pixels of the second polarimetric image.

The method may further include determining a type of the material of a vehicle seat upholstery and to identify the presumed wet area further based on the determined material, estimating a first threshold for a rate of change of a degree of polarization from a time of a spill and a second threshold for a rate of change of an angle of polarization, based on the determined material of the seat, capturing a plurality of second polarimetric images upon determining that the vehicle seat is unoccupied, determining the rate of change of the degree of polarization and the rate of change of the angle of polarization based on the captured plurality of second polarimetric images, and identifying the wet area further based on (i) the determined rate of change of the degree of polarization, (ii) the determined rate of change of the angle of polarization, (iii) the first threshold, and (iv) the second threshold.

Further disclosed is a computing device programmed to execute any of the above method steps. Yet further disclosed is a vehicle comprising the computing device.

Yet further disclosed is a computer program product comprising a computer-readable medium storing instructions executable by a computer processor, to execute any of the above method steps.

System Elements

A water layer on a surface may change a return light signal from the surface. Based on changes of return light signals, a wet surface may be detected. A computer, e.g., a vehicle computer, can be programmed to determine a baseline polarization for a surface of a material, e.g., a vehicle seat covering, based on a first polarimetric image of the surface, to determine a second polarization for the surface based on a second polarimetric image of the surface. The computer can be programmed to determine, based on the baseline polarization and the second polarization, that there is a wet area on the surface. The computer can be programmed, upon determining the wet area, to actuate an actuator to cause cleaning of the surface.

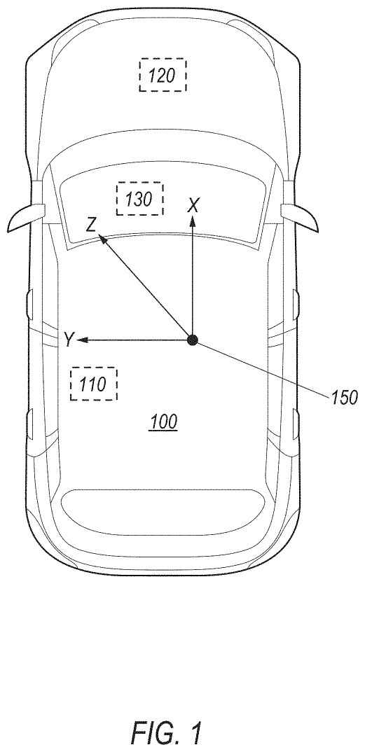

FIG. 1 illustrates a vehicle 100. The vehicle 100 may be powered in a variety of ways, e.g., with an electric motor and/or internal combustion engine. The vehicle 100 may be a land vehicle such as a car, truck, etc. A vehicle 100 may include a computer 110, actuator(s) 120, and sensor(s) 130. The vehicle 100 can have a reference point 150, e.g., a geometric center (i.e., a point where a longitudinal axis and a lateral axis of a vehicle 100 body intersect), or some other specified point.

The computer 110 includes a processor and a memory such as are known. The memory includes one or more forms of computer-readable media, and stores instructions executable by the computer 110 for performing various operations, including as disclosed herein. Additionally or alternatively, the computer 110 may include a dedicated electronic circuit that is an integrated circuit developed for a particular use, as opposed to a general-purpose device. In one example, a dedicated electronic circuit may include an Application-Specific Integrated Circuit (ASIC) that is manufactured for a particular operation, e.g., an ASIC for calculating a histogram of received images of a sensor 130. In another example, a dedicated electronic circuit includes a Field-Programmable Gate Array (FPGA) which is an integrated circuit manufactured to be configurable by a customer. Typically, a hardware description language such as Very High Speed Integrated Circuit Hardware Description Language (VHDL) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included inside a chip packaging.

In the context of this document, a statement that the computer 110 is programmed to execute an instruction or function can mean that (i) a general purpose computer (i.e., including a general purpose CPU) is programmed to execute program instructions, and/or (ii) an electronic circuit performs an operation specified based on a hardware description language programming such as VHDL, as discussed above.

In one example, a dedicated electronic circuit may process received image data from an image sensor 130 and calculate a polarization angle and/or a polarization degree of each image pixel, and a processor of the computer 110 may be programmed to receive data from the dedicated electronic circuit and actuate a vehicle 100 actuator 120.

The computer 110 may operate the vehicle 100 in an autonomous mode, a semi-autonomous mode, or a non-autonomous mode. For purposes of this disclosure, an autonomous mode is defined as one in which each of vehicle 100 propulsion, braking, and steering are controlled by the computer 110; in a semi-autonomous mode the computer 110 controls one or two of vehicles 100 propulsion, braking, and steering; in a non-autonomous mode, an operator occupant, i.e., one of the one or more occupant(s), controls the vehicle 100 propulsion, braking, and steering.

The computer 110 may include programming to operate one or more of vehicle 100 brakes, propulsion (e.g., control of vehicle 100 speed and/or acceleration by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations. For example, the computer 110 may determine that in the non-autonomous mode, a human operator is to control the propulsion, steering, and braking operations.

The computer 110 may include or be communicatively coupled to, e.g., via a vehicle 100 communications bus as described further below, more than one processor, e.g., controllers or the like included in the vehicle for monitoring and/or controlling various vehicle controllers, e.g., a powertrain controller, a brake controller, a steering controller, etc. The computer 110 is generally arranged for communications on a vehicle communication network that can include a bus in the vehicle such as a controller area network (CAN) or the like, and/or other wired and/or wireless mechanisms.

Via the vehicle 100 network, the computer 110 may transmit messages to various devices in the vehicle and/or receive messages from the various devices, e.g., an actuator 120, a user interface, etc. Alternatively or additionally, in cases where the computer 110 comprises multiple devices, the vehicle 100 communication network may be used for communications between devices represented as the computer 110 in this disclosure. As discussed further below, various electronic controllers and/or sensors 130 may provide data to the computer 110 via the vehicle communication network.

The vehicle 100 actuators 120 are implemented via circuits, chips, or other electronic and/or mechanical components that can actuate various vehicle subsystems in accordance with appropriate control signals, as is known. The actuators 120 may be used to control vehicle 100 systems such as braking, acceleration, and/or steering of the vehicles 100. The vehicle 100 may include a seat heating actuator 120 (or seat heater), e.g., to warm a vehicle 100 seat on a cold day, to dry a wet seat after fluid has spilled over the seat, etc.

Vehicle 100 sensors 130 may include a variety of devices known to provide data via the vehicle communications bus. FIG. 1 shows an example camera sensor 130. For example, the sensors 130 may include one or more camera sensors 130, radar, infrared, and/or LIDAR sensors 130 disposed in the vehicle 100 and/or on the vehicle 100 providing data encompassing at least some of the vehicle 100 interior and exterior. The data may be received by the computer 110 through a suitable interface. A camera sensor 130 disposed in and/or on the vehicle 100 may provide object data including relative locations, sizes, and shapes of objects such as a vehicle 100 seat, and/or objects surrounding the vehicle 100, e.g., other vehicles.

In the present context, a field of view of a camera sensor 130 is a portion of an area in which objects such as a seat can be detected by the sensors 130. The field of view may include outside and/or inside of the vehicle 100. Additionally or alternatively, in the present context, a camera sensor 130 may be mounted to a location outside of a vehicle, e.g., in a building, having a field of view including, e.g., a portion of a room in a building. Additionally or alternatively, a camera sensor 130 may be mounted to some other mobile device, e.g., a mobile robot, and directed to a surface, e.g., a floor, a wall, a work bench, etc., based on a location and direction of the mobile device.

Sensors 130 can detect object locations according to two and/or three dimensional coordinate systems. For example, three-dimensional (3D) location coordinates may be specified in a 3D Cartesian coordinate system with an origin point, e.g., reference point 150. For example, location coordinates of a point on a vehicle 100 seat may be specified by X, Y, and Z coordinates. In the present context, a surface includes points on an outer surface of an object such as a seat, a table, etc. In another example, location coordinates of a point on a surface, e.g., a floor of a room, a surface of a work bench, etc., may be specified by X, Y, and Z coordinates with reference to an origin, e.g., a GPS (General Positioning System) reference point, a reference point of a coordinate system local to a building, etc.

A distribution of light waves that are uniformly vibrating in more than one direction is referred to as unpolarized light. Polarized light waves are light waves in which the vibrations occur wholly or partially in a single plane. Polarization of light (or a light beam) may be specified with a degree of polarization and a direction of polarization. It is further known that a polarization of light may additionally or alternatively be specified by Stokes parameters, which include an intensity I, a degree of polarization DOP, an angle of polarization AOP, and shape parameters of a polarization ellipse. The process of transforming unpolarized light into polarized light is known as polarization. The direction of polarization is defined to be a direction parallel to an electromagnetic field of the light wave. A direction of polarization (i.e., a direction of vibration) may be specified with an angle of polarization between 0 and 360 degrees. Unpolarized light includes many light waves (or rays) having random polarization directions, e.g., sunlight, moonlight, fluorescent light, vehicle headlights, etc. Light reflected from a wet surface, e.g., a wet seat, may include polarized light waves, as discussed below. The direction of polarization in such cases would tend to be aligned with the orientation of the wet surface from which the light reflected. Properties of return light signals include intensity, light field, wavelength(s), polarization, etc. A material may vary in how it reflects light, and a material with a wet surface may differ in its reflectance properties compared to a dry surface.

Light can be polarized by passage or reflectance through a polarizing filter or other polarizing material. A degree of polarization is a quantity used to describe the portion of an electromagnetic wave that is polarized. A perfectly polarized wave has a degree of polarization DOP (or polarization degree) of 100% (i.e., restricting light waves to one direction), whereas an unpolarized wave has a degree of polarization of 0% (i.e., no restriction with respect to a direction of vibration of a light wave). For example, laser light emissions are known to be fully polarized. A partially polarized light wave can be represented by a combination of polarized and unpolarized components, thus having a polarization degree between 0 and 100%. A degree of polarization is calculated as a fraction of a total power that is carried by the polarized component of the light wave. The computer 110 may be programmed to determine a degree of polarization for each pixel of a polarimetric image received from the camera sensor 130.

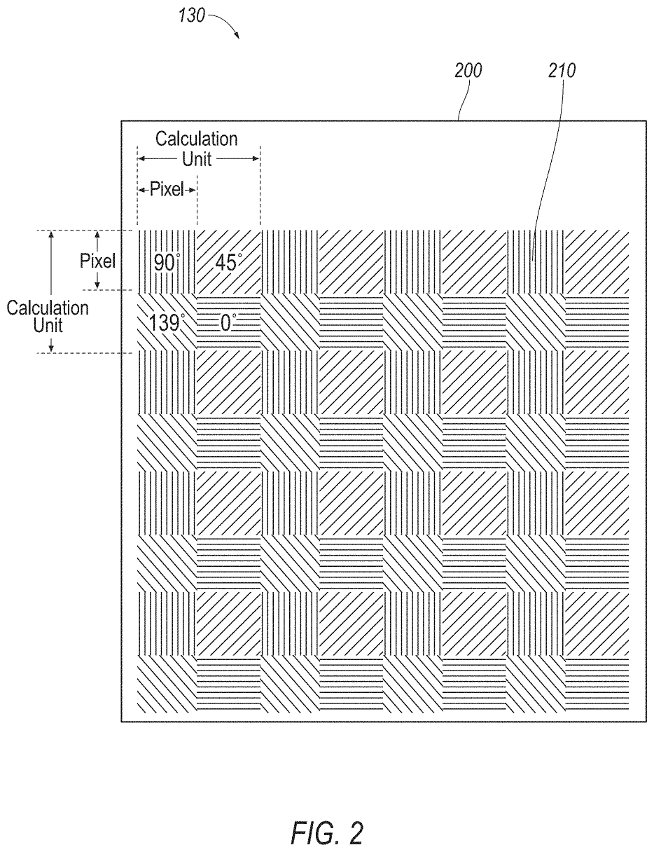

A polarimetric image, in the present context, is an image received from a polarimetric 2D or 3D camera sensor 130. A polarimetric camera sensor 130 is a digital camera including optical and/or electronic components, e.g., an image sensing device 200, as shown in FIG. 2, configured to filter polarized light and detect the polarization of the received light. Other filtering methods may also be possible to create a polarized image data. A polarimetric camera sensor 130 may determine a degree of polarization of received light in various polarization directions. Light has physical properties such as brightness (or amplitude), color (or wavelength), polarization direction, and a polarization degree. For example, unpolarized light may have a population of light waves uniformly distributed in various directions (i.e., having different directions) resulting in a “low” polarization degree (i.e., below a specified threshold) and fully polarized light may include light waves having one direction resulting in a “high” polarization degree (i.e., above a specified threshold). In the present context, a “low” polarization degree may be 0% to 10%, and a “high” polarization degree may be defined as 90% to 100%. Each of these physical properties may be determined by a polarimetric camera sensor 130. A polarimetric camera sensor 130, e.g., using Polarized Filter Array (PFA), is an imaging device capable of analyzing the polarization state of light in a snapshot way. The polarimetric camera sensors 130 exhibit spatial variations, i.e., nonuniformity, in their response due to optical imperfections introduced during the nanofabrication process. Calibration is done by computational imaging algorithms to correct the data for radiometric and polarimetric errors.

FIG. 2 illustrates an example polarizing camera sensor 130. A polarizing camera sensor 130 typically includes a lens (not shown) that focuses received light on an image sensing device 200. Polarizing image sensing device 200 is an optoelectronic component that converts light to electrical signals such as a CCD or CMOS sensor. Image data output from an image sensing device 200 typically includes a plurality of pixels, e.g., an array consisting of a million pixel elements also known as 1 megapixel. The image sensing device 200 may include a plurality of individual optoelectronic components 210, each generating an electrical signal for each respective image pixel. Image data generated by the image sensing device 200 for each image pixel may be based on image attributes including a polarization direction (or axis), polarization degree, an intensity, and/or a color space.

To filter detected polarized light, a polarizing material, e.g., in form of a film, may be placed on the image sensing device 200 and/or may be included in the image sensing device 200. For example, to produce a polarizing film, tiny crystallites of iodoquinine sulfate, oriented in the same direction, may be embedded in a transparent polymeric film to prevent migration and reorientation of the crystals. As another example, Polarized Filter Array (PFA) may be used to produce polarizing films. PFAs may include metal wire grid micro-structures, liquid crystals, waveplate array of silica glass, and/or intrinsically polarization-sensitive detectors. As shown in FIG. 2, the polarizing material on each optoelectronic component 210 may be arranged such that light with a specific polarization direction, e.g., 0 (zero), 45, 90, 270 degrees, passes through the polarizing film. In one example, each optoelectronic component 210 generates image data corresponding to one or more image pixels. In one example, the optoelectronic components 210 of the image sensing device 200 may be arranged such that each set of 2×2 optoelectronic components 210 includes one of 0 (zero), 45, 90, and 270 degree polarizing films. A polarimetric image is then produced using de-mosaicking techniques such as are known, as discussed below. Additionally or alternatively, other techniques may be used to produce the polarimetric image, such as a spinning filter, electro-optical filter, etc.

A received image typically includes noise. Noise levels may vary depending on ambient light conditions and/or camera parameters such as exposure time, gain, interaction between noise and algorithms used to compute color or polarization, etc. An amount of noise in an image is typically specified as a “noise ratio” or “signal-to-noise ratio” (SNR). Signal-to-noise ratio is a measure to specify a desired signal compared to a level of noise in the received data. SNR is specified as a ratio of signal power to noise power, often expressed in decibels (dB). A ratio higher than 1:1 (greater than 0 dB) indicates more signal than noise. Camera sensor 130 parameters (or camera parameters) include parameters such as (i) exposure time, i.e., a length of time when the optoelectronic imaging component(s) 210 are exposed to light based on adjusted shutter time, (ii) camera gain which controls an amplification of image signal received from the image sensing device 200. A camera sensor 130 may include an Image Signal Processor (ISP) that receives image data from the imaging sensor 200 and performs de-mosaicking for color and/or polarimetric characteristics, noise reduction, adjusting of exposure time, auto focus, auto white balance, gain control (e.g., auto gain control), etc.

As discussed above, each of the optoelectronic components 210 of the image sensing device 200 may detect light that has a specific polarization direction. For example, an optoelectronic component 210 may detect light with a polarization direction of 90 degrees. The computer 110 may be programmed to generate an image based on outputs of the optoelectronic components 210. This process is typically referred to as “de-mosaicking.” In a de-mosaicking process, the computer 110 may combine the image data received from each of the 2×2 adjacent optoelectronic sensors 210 and calculate the polarization degree, intensity I, and polarization direction of the received light for the set of 4 (four) optoelectronic components 210, e.g., assuming a degree of polarization of 45 degrees for the portion of image that is received from the optoelectronic component 210 having a 90 degree polarization film. In other words, considering the relatively small size of pixels, it can be assumed that light received at a pixel on a 90 degree polarization film has a same 45 degree polarization component as light received at an adjacent pixel, i.e., within a same set four optoelectronic components 210. The image produced from de-mosaicking is referred to as the de-mosaicked image.

The computer 110 may be programmed to determine an intensity, polarization direction, and degree of polarization, e.g., for each image pixel, based on data received from the camera sensor 130. The computer 110 may be programmed to generate a polarization map based on the received image data. The polarization map may include a set that includes an intensity (e.g., specified in candela), an angle of polarization (e.g., 0 to 360 degrees), and a degree of polarization (e.g., 0 to 100%), color, light intensity, etc., for each pixel of the polarimetric image.

In one example, the computer 110 may be programmed to generate a polarization map including a set of polarization data for each pixel of the image such as the example shown in Table 1. Thus, the polarization map may specify whether polarized light with each of the four polarization directions detected and specify a polarization degree for each of the polarization directions. The computer 110 may be programmed to determine an angle of polarization for a pixel of an image based on the determined degree of polarization of light in each of the plurality of directions, e.g., 0, 45, 90, and 270 degrees. In one example, the computer 110 may determine the angle of polarization of a pixel to be an average of the determined polarization in each of the specified directions.

The computer 110 may be programmed to generate the polarization map based on image data received from the image sensing device 200 of the camera sensor 130. Additionally or alternatively, the camera sensor 130 may include electronic components that generate the polarization map and output the polarization map data to the computer 110. Thus, the computer 110 may receive polarization data, e.g., as illustrated by Table 1, for each pixel or set of pixels, from the polarimetric camera sensor 130.

TABLE 1

| Data | Description |
|---|---|
| Luminosity or intensity | Specified in candela (cd) or a percentage rate from 0 (zero)% |
| | (completely dark) to 100% (completely bright). |
| 0 (zero) degree polarization | A degree of polarization of light at the polarization direction |
| degree | of 0 (zero) degrees, e.g., a number between 0 (zero) and 100%. |
| 45 degree polarization | A degree of polarization of light at the polarization direction |
| | of 45 degrees, e.g., a number between 0 (zero) and 100%. |
| 90 degree polarization | A degree of polarization of light at the polarization direction of |
| | 90 degrees, e.g., a number between 0 (zero) and 100%. |
| 270 degree polarization | A degree of polarization of light at the polarization direction of |
| | 270 degrees, e.g., a number between 0 (zero) and 100%. |

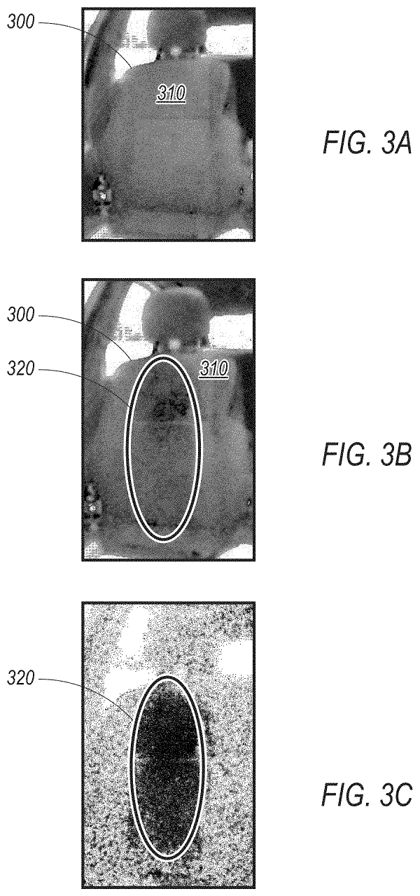

A light beam hitting a surface, e.g., a vehicle 100 seat 300 (FIG. 3A), may be absorbed, diffused (or refracted) and/or reflected, as is known. Diffuse light reflection is a reflection of light or other waves or particles from a surface 310 such that a light beam incident on the surface 310 is scattered at many angles rather than at just one angle as in a case of specular reflection. Many common materials, e.g., upholstery, leather, fabric, etc., exhibit a mixture of specular and diffuse reflections. A light hitting a surface 310 that is wet, e.g., a wet area 320, is substantially reflected (i.e., more reflected than diffused compared to a same surface in dry condition which would rather diffuse light instead of reflecting). This interaction function may be modeled using a bidirectional reflectance distribution function, Spatially Varying Bidirectional Reflectance Distribution Function, Bidirectional Texture Function, Bidirectional Surface Scattering Reflectance Distribution Function, or other model. In addition, the polarimetric characteristics of light may be included into a polarimetric bidirectional reflectance distribution function as known in the art. A given material may be exposed to liquids of varying properties, e.g., mostly transparent blue liquid, mostly transparent yellow liquid, mostly opaque black liquid, etc., and the interaction function may be measured in a controlled setting, e.g., under controlled global illumination conditions. Thereafter, the global illumination in the environment can be predicted or measured, e.g., utilizing time of day to determine sun position and color temperature of the environment, e.g., inside a vehicle.

The computer 110 can be programmed to determine a baseline polarization map (or baseline polarization) for a surface of a material, e.g., seat 300 surface 310, based on a first polarimetric image of the surface 310, to determine a second polarization map (or second polarization) for the surface 310 based on a second polarimetric image of the vehicle 100. The computer 110 can be programmed to determine, based on the baseline polarization map and the second polarization map, that there is a wet area 320 on the surface 310. The computer 110 can be programmed, upon determining the wet area 320, to actuate an actuator 120 to cause a cleaning of the surface 310. Additionally or alternatively, the computer 110 may be programmed to determine polarimetric bidirectional reflectance distribution function (pBRDF) parameters of the baseline and pBRDF parameters of the second map. The computer 110 then determines if a shift occurred due to a wet surface 320, and thus, be less sensitive to uncertainty of global illumination of the surface 310. BRDF is a function that defines how light is reflected on an opaque surface 310. In other words, BRDF describes the relation between the incoming and outgoing radiances at a given point on the surface 310. BRDF may be specified in units of sr⁻¹. sr stands for steradians.

The computer 110 may be programmed to actuate an actuator 120 such as a seat heater to dry the wet area 320. In another example, the computer 110 may be programmed to output information about the wet area 320, e.g., via a user interface. In another example, the computer 110 may be programmed to navigate the vehicle 100 to a specified location for service. In another example, the computer 110 may be programmed, upon detecting a wet area on a room floor or a work bench, to actuate a robot or the like to dry the wet area, by blowing air.

A wet area 320, in the present context, is a portion of a surface 310 that is wet due to a presence of a liquid, e.g., water, a beverage, urine, etc. A wet area 320 may have various symmetrical, e.g., round, or asymmetrical shapes. A surface amount of a wet area 320 may be specified in square centimeters (cm²). A porous wet surface 320 may have an amount of liquid per given volume in the surface 310 layers of the material which may be specified in units of Homer per square cubits (Ho/cubit²).

The baseline polarization map specifies a polarization map of the surface 310 in a dry condition, i.e., without any wet area(s) 320. In one example, the computer 110 determines that the surface 310 is dry based on a user input and/or based on an idle time of the vehicle 100, e.g., an idle time exceeding 24 hours. In another example, the computer 110 specifies a polarization map of a surface such as a room floor, a work bench surface, etc., based on data received from a camera sensor 130 mounted to a pole, a building, and/or a mobile robot. The computer 110 may store the baseline polarization map in a computer 110 memory. The baseline polarization map includes a baseline degree of polarization and a baseline angle of polarization. The computer 110 may be programmed to determine the baseline polarization of each pixel, e.g., including the angle of polarization and degree of polarization of each pixel, based on the first polarimetric image (FIG. 3A). In one example, the computer 110 may be programmed to receive a plurality of polarimetric images, and to then determine the baseline polarization map based on, e.g., an average, a mean, or other statistical characteristic value, of the polarization maps corresponding to each of the received polarimetric images. In such an example, each pixel's angle of polarization, degree of polarization, etc., may be determined using a statistical method, e.g., average, mean, etc. of values of corresponding pixels in the received images.

To ensure there is sufficient light available at a time of capturing a polarimetric image, the computer 110 may be programmed to capture the first polarimetric image upon determining, based on received sensor 130 data, that a light intensity in the vehicle 100 interior or any other area in which the image is being captured, e.g., a work bench, etc., exceeds a threshold, e.g., 500 candela per square meter (cd/m²), which may be empirically determined. The threshold may be determined such that the polarization maps, as discussed above, can be determined. The light intensity may be specified in cd/m². The computer 110 may be programmed to determine the light intensity of the vehicle 100 interior based on data received from a light sensor 130. A light sensor 130, e.g., an interior light sensor 130, may output an electrical voltage and/or current that changes analog to changes of the received light intensity.

The computer 110 may be programmed to actuate a light in the vehicle 100 interior upon determining that the light intensity in the vehicle 100 interior is less than the threshold, and to capture the first polarimetric image after actuation of the interior light. Additionally or alternatively, upon determining that the light intensity in the vehicle 100 interior is less than the threshold, the computer 110 may be programmed to increase an exposure time of the camera sensor 130 and/or to actuate the camera sensor 130 to capture a multi-exposure HDR (high definition range) image, etc. Additionally or alternatively, upon determining nighttime conditions based on data received from a vehicle 100 light sensor 130, the computer 110 may be programmed to actuate an NIR (near infrared) light source to illuminate the surface 310.

The computer 110 may receive the second polarimetric image of the surface 310 and determine whether the surface 310 is wet. The second polarization map includes a second degree of polarization and a second angle of polarization for each pixel of the second polarimetric image.

To determine whether the surface 310 is dry, a view of the surface 310 by the camera sensor 130 need to be unobstructed. In one example, the computer 110 may be programmed to capture the second polarimetric image upon determining that a viewing of the surface 310 is not obstructed, e.g., a seat including the surface 310 is unoccupied, a work bench is empty, a shipping container storage area that is empty, etc. For example, the computer 110 may be programmed to capture the second polarimetric image based at least in part on determining that a vehicle 100 door is open, e.g., using vehicle 100 door sensor 130 data. The door sensor 130 may output data including “door open” and “door closed.” In another example, the computer 110 may be programmed to determine that the vehicle 100 seat is unoccupied based on data received from a seat occupancy sensor 130, e.g., determining a weight applied on the occupancy sensor 130 mounted under the seat is less than a threshold, e.g., 10 kilogram (kg). The computer 110 may actuate an actuator 120in the vehicle 100 to move the surface 310 to a specified position before obtaining a second polarization map, e.g., returning the seat 300 to an upright position. Thus, a seat 300 position and/or angle may be stored in a computer 110 memory and the computer 110 may be programmed to move the seat 300 and/or surface 310 based on the stored information, e.g., by actuating a seat 300 actuator. Additionally or alternatively, other computer vision techniques may be used to align pixels in the baseline polarization map to the second polarization map's corresponding pixels.

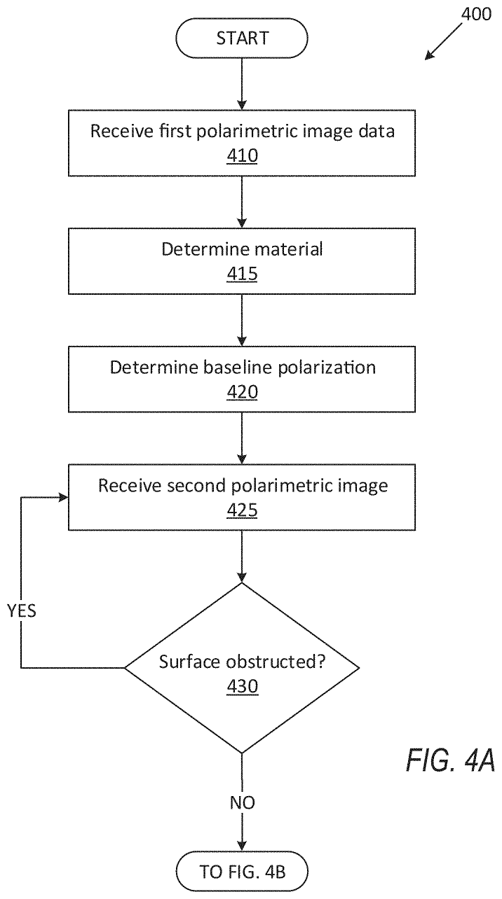

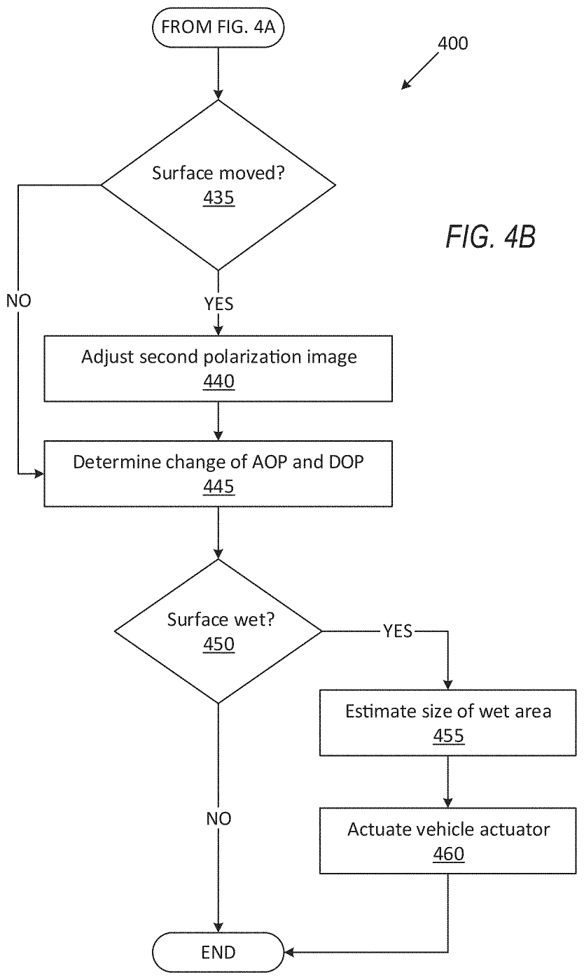

In another example, as discussed with respect to FIGS. 4A-4B, the computer 110 may be programmed to iteratively capture images and based on the image determine whether the surface 310 is unobstructed. The computer 110 may be programmed to determine that that surface 310 is not obstructed, e.g., the seat 300 is unoccupied, based on a template matching technique. The computer 110 may be programmed to determine that the seat 300 is occupied upon detecting a torso and/or a head of a human user at the specified location of the seat 300. The computer 110 may be programmed to determine that the seat 300 is unoccupied upon determining based on determining a shape of the seat 300 in an image that matches a stored shape of the seat 300 using, e.g., supervised learning, convolution neural networks, etc. Upon determining that the surface 310 is unobstructed, the computer 110 may determine to use the captured polarimetric image to generate the second polarization map.

The computer 110 may be programmed to identify the wet area 320 as an area for which a change of angle of polarization for a plurality of pixels exceeds an angle threshold, e.g., 10 degrees. FIG. 3A shows a first polarimetric image based on which the baseline polarization map is generated. FIG. 3B shows a second polarimetric image based on which the computer 110 generates the second polarization map. Although FIG. 3A-3B are grayscale images to comply with 37 CFR § 1.84, a polarization image may be shown as a color image in which colors indicate differences in degree of polarization, angle of polarization, etc. FIG. 3C shows an image which illustrates a result of comparing the first and second polarization maps. For example, each pixel of FIG. 3C may represent a difference between angle of polarization of the first and second polarization maps at the corresponding pixel. In one example, a brighter color indicates less difference and a darker color indicates a larger difference, e.g., a dark-colored pixel may indicate a difference of angle of polarization greater than 10 degrees.

The area 320 in FIG. 3C corresponds to an area with a polarization map parameter, e.g., an angle of polarization, difference exceeding a threshold, e.g., 10 degrees. The second polarization map may include an angle of polarization for a plurality of pixels of the image of the surface 310. For example, the polarization maps may include an angle of polarization and/or degree of polarization of the image pixels corresponding to a specified area such as a seat 300 surface 310, a work bench top surface, a room floor surface, etc.

The computer 110 may be programmed to determine a change of angle of polarization for an image pixel by comparing the angle of polarization of a first pixel of the baseline polarization map at coordinates m, n to the angle of polarization of a second pixel of the second polarization map at coordinates m, n. The polarimetric images are typically 2D images. Coordinates m, n are typically specified with respect to an image reference point (or pixel), i.e., an origin, e.g., at bottom left corner of the image. In some examples, the polarimetric images may be 3D images, thus including a third coordinate p with respect to the image reference point. Additionally or alternatively, a polarization map may be specified in form of a matrix with numbered rows and columns. The computer 110 may be programmed to store a relationship between image pixels and points on surface(s) 310 in the real world. For example, the computer 110 may store data specifying that an image coordinate m, n corresponds to a location coordinate x, y, z on the seat 300 surface 310. In one example, the computer 110 may be programmed to detect a wet area 320 upon determining that at least a specified number of pixels, e.g., 100, associated with the area 320 have an angle of polarization exceeding the threshold.

The computer 110 may be programmed to identify the wet area 320 further as an area for which a degree of polarization exceeds a degree of polarization threshold, e.g., 10%. In another example, an area 320 as shown in FIG. 3C may illustrate the pixels with a degree of polarization in comparison to the degree of polarization in the baseline polarization map exceeding 10%. In yet another example, the computer 110 may detect a wet area 320 based on determining that (i) a change in the angle of polarization exceeding a threshold, and/or (ii) a degree of polarization is greater than a threshold (or a change of degree of polarization compared to the baseline polarization map exceeding a threshold). Alternatively or additionally, the computer 110 may be programmed to detect a volume of liquid per surface 310 area, e.g., 5 milliliter per centimeter square (ml/cm²), based on a decision tree of multiple image/pixel attributes, a neural network, computation of a pBRDF's parameter correlated to features of interest, etc. The pixel attributes may include intensity, polarization, color, and the relative change thereof.

Spilled fluid on seat 300 upholstery like fabric may be absorbed within, e.g., 60 seconds, whereas spilled fluid on leather may pool and/or roll off the surface 310 based on a slope of the surface 310 and exit a field of view of the camera sensor 130 without being absorbed by the leather surface 310. The computer 110 may be programmed to identify a type of the material of a surface, e.g., a seat 300 surface 310 material (or upholstery), a floor, a wall, a table, a work bench top surface, etc., and to identify the presumed wet area 320 further based on the determined material. In some examples, the computer 110 may have stored data of the material type and properties within the field of view of the camera.

In one example, the computer 110 may be programmed to identify a texture of the surface 310 material based on a neural network trained to detect a texture using image data. For example, the computer 110 may be programmed to train a neural network based on texture ground truth data to identify various materials such as leather, faux leather, fabric, wood, and plastic. In one example, the ground truth data may include a set of images, e.g., 5,000 images, of various types of leather, faux leather, fabric, plastic, etc. The neural network receives the images of each texture and the corresponding texture identifier. The computer 110 may be programmed to identify the texture of the surface 310 of the seat 300 based on an output of the trained neural network. Additionally or alternatively, the computer 110 may be programmed to store type of the surface 310 material in a computer 110 memory.

As discussed above, fluid spilled on a fabric surface 310 may be absorbed and dimensions of the wet area 320 may increase due to absorption, whereas a spill of fluid on leather surface 310 may run off and therefore dimensions of the wet area 320 may change, e.g., decrease over time. The computer 110 may store data including a rate of change of angle of polarization, a rate of change of degree of polarization, a rate of change of dimensions of a wet area, etc., in relation to the type of material. Such information may be determined using empirical tests, e.g., spilling fluid on different material, and capturing polarimetric images at specified times, e.g., 0, 15, 30, 45, 60 seconds, after the spill. In one example, upon entering the determined empirical data to the computer 110, the computer 110 may determine and store a rate of change of a polarization angle threshold, a rate of change of a degree of polarization threshold, etc., corresponding to each type of material. With such stored data, a volume of spill liquid may be estimated more accurately and an actuation based on the detected spill may be better adjusted by the computer 110.

Table 2 shows an example set of data including rates of change of angle of polarization and rates of change of degree of polarization for various surface 310 material. The data included in Table 2 may be result of an empirical test as described above. The computer 110 may be programmed to estimate a first threshold for a rate of change of a degree of polarization from a time of a spill and a second threshold for a rate of change of an angle of polarization, based on the determined material of the surface 310 and the stored example data included in Table 2. The computer 110 may be programmed to determine a first threshold for rate of change of the angle of polarization and a second threshold for a rate of change of degree of polarization. In one example, the first and second threshold are determined based on Table 2. For example, a first threshold for rate of change of AOP for fabric may be 8 degrees (e.g., 20% less than the average data included in Table 2.) The thresholds may be determined using empirical techniques.

TABLE 2

| | Rate of change of AOP | |
|---|---|---|
| Material type | (degrees/s) | Rate of change of DOP (%/s) |
| Fabric | 10 | 10 |
| Leather | 15 | 30 |
| Faux leather | 18 | 25 |

The computer 110 may be programmed to capture a plurality of second polarimetric images upon determining that a vehicle seat is unoccupied. The computer 110 may be programmed to determine the rate of change of the degree of polarization and the rate of change of the angle of polarization based on the captured plurality of second polarimetric images, and to identify the wet area further based on (i) the determined rate of change of the degree of polarization, (ii) the determined rate of change of the angle of polarization, (iii) the first threshold, and (iv) the second threshold. For example, the computer 110 may be programmed to determine a parameter such as a viscosity of a fluid causing a wet area 320 on a fabric material upon determining that a rate of change of AOP exceeds 8 degrees/second and/or the angle of polarization exceeds 10 degrees. The computer 110 may be programmed to determine the fluid parameter such as a viscosity further based on a statistical change detection, e.g., using a Kalman filter, Bayesean change point detection, etc.

The baseline polarimetric map may be based on a position of the surface 310 which is different from a second position of the surface 310 in the second polarization map. For example, a seat 300 position in the second polarimetric image may be different from the second position of the seat 300 in the second polarimetric image, e.g., due to a seat-back adjustment, forward or backward movement, an object causing deformation, etc. “Position” refers to 3D location of the surface 310, e.g., 3D location coordinates of a reference point of a surface, e.g., backrest or cushion, to a reference point 150 of the vehicle 100. The computer 110 may be programmed to, upon determining that the surface 310 position in the second polarimetric image is changed with respect to the first polarimetric image, to adjust the second polarimetric image using a template matching technique, as discussed below.

The computer 110 may be programmed to detect a change in a position of the seat 300, adjust the second polarimetric image based on the detected change in the position of the seat 300, and to determine whether the seat 300 is wet based at least in part on the adjusted second polarimetric image. The computer 110 may be programmed to generate the adjusted second polarimetric image using, e.g., a perspective transformation technique. A “perspective transformation” is a line-preserving projective mapping of points observed from two different perspectives after determining the homography between pixel points in the image. “Line preserving” means that if multiple points are on a same line in the first polarimetric image, the same points are on a same line in the second polarimetric image. The transformation may be based on prior knowledge of the three dimension structure in the field of view of the camera and allowable object motion (e.g., seat back inclination). A homography of the features identified in the images may return a homography matrix that transforms the location coordinates of the feature points. In other words, the homography provides a mathematical relationship between the coordinates of the points of the images. In an adjusted second polarimetric image, the coordinates of a pixel match to the coordinates of the first polarimetric image. Thus, the computer 110 may compare polarization parameters of a pixel at coordinates m, n of the first image to a pixel of the adjusted second polarimetric image at the coordinates m, n.

FIGS. 4A-4B together are a flowchart of an exemplary process 400 for detecting a wet area 320 on a surface 310. The computer 110 may be programmed to execute blocks of the process 400.

With reference to FIG. 4A, the process 400 begins in a block 410, the computer 110 receives a first polarimetric image from a polarimetric camera sensor 130. The computer 110 may be programmed to receive the first polarimetric image upon determining that the surface 310 is dry, e.g., based on user input and/or determining that the vehicle 100 was unoccupied for at least specified time such as 24 hours. The computer 110 may be programed to receive the first polarimetric image from a remote computer. In another example, the computer 110 may be programmed to receive data from a remote computer indicating that a surface included in the image data is dry.

Next, in a block 415, the computer 110 determines the material covering the surface 310. The computer 110 may be programmed to determine the type of material by determining a texture of the material, e.g., using a trained neural network. In another example, the computer 110 may store information in a computer 110 memory including a type of the material covering of the surface 310.

Next, in a block 420, the computer 110 determines the baseline polarimetric map. The computer 110 may be programmed to determine the polarimetric map including angle of polarization and degree of polarization of the pixels of the first polarimetric image.

Next, in a block 425, the computer 110 receives a second polarimetric image from the polarimetric camera sensor 130.

Next, in a decision block 430, the computer 110 determines whether the surface 310 is obstructed. For example, the computer 110 may be programmed to determine whether the vehicle 100 seat 300 is occupied (FIG. 3A). The computer 110 may be programmed to determine whether the surface 310 is obstructed, e.g., the seat 300 is occupied, based on seat occupancy sensor 130 data, template matching techniques, etc. If the computer 110 determines that the surface 310 is obstructed, then the process 400 returns to the block 425; otherwise the process 400 proceeds to a decision block 435 (FIG. 4B).

With reference to FIG. 4B, in the decision block 435, the computer 110 determines whether the surface 310 has moved. The computer 110 determines whether, e.g., the seat 300, has moved relative to the seat 300 position captured in the first polarimetric image. The computer 110 may be programmed to determine a change of position using, e.g., a perspective transformation technique. If the computer 110 determines that the surface 310 has moved, then the process 400 proceeds to a block 440; otherwise the process 400 proceeds to a block 445.

In the block 440, the computer 110 adjusts the second polarization image based on, e.g., the determined perspective transformation.

In the block 445, which can be reached from either of the blocks 435 or 440, the computer 110 determines a change of angle of polarization and a change of degree of polarization based on the baseline polarization map and the second polarization map. Additionally or alternatively, the computer 110 may be programmed to determine a rate of change of angle of polarization and a rate of change of degree of polarization based on multiple polarimetric images, as discussed with reference to Table 2.

Next, in a decision block 450, the computer 110 determines whether the surface 310 is wet. The computer 110 may be programmed to determine a wet area 320 based on determining that (i) a change in angle of polarization exceeds a threshold, and/or (ii) a degree of polarization is greater than a threshold. In another example, the computer 110 may be programmed to determine a wet area 320 based on a determined type of material, the determined rate of change of angle of polarization, the determined rate of change of degree of polarization, and stored first and second thresholds for rate of change of degree of polarization and rate of change of angle of polarization, as discussed with respect to Table 2. If the computer 110 detects a wet area 320 on the surface 310, then the process 400 proceeds to a block 455; otherwise the process 400 ends, or alternatively returns to the block 410, although not shown in FIGS. 4A-4B.

In the block 455, the computer 110 estimates dimensions of the wet area 320. The computer 110 may be programmed to estimate the dimensions, e.g., surface amount, of the wet area 320 by estimating a number of pixels within the perimeter of the detected wet area 320. In one example, the computer 110 may store data specifying real dimensions of a surface 310 corresponding to a pixel, e.g., 5×5 centimeter (cm). Thus, the computer 110 may determine that a wet area 320 occupying an image area of 2×2 pixels has approximate dimensions of 10×10 cm. In another example, the computer 110 may be programmed to determine dimensions of wet area 320 using image processing techniques.

Next, in a block 460, the computer 110 actuates a vehicle 100 actuator 120. For example, the computer 110 may be programmed to actuate a vehicle 100 seat heating actuator 120. Additionally or alternatively, the computer 110 may be programmed to actuate a vehicle 100 window opener to open a vehicle 100 window. Additionally or alternatively, the computer 110 may actuate a vehicle 100 door lock to restrict access to a wet surface 320. For example upon determining a wet surface 320 on a rear right seat 300, the computer 110 may be programmed to lock the rear right door of the vehicle 100 to restrict access of a user to the corresponding seat 300.

Following the block 460, the process 400 ends, or alternatively returns to the block 410, although not shown in FIGS. 4A-4B.

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Intercal, Java™ C, C++, Visual Basic, Java Script, Perl, Python, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random-access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A system, comprising a processor and a memory, the memory storing instructions executable by the processor to:
determine a baseline polarization for a surface of a material based on a first polarimetric image of the surface;
determine a second polarization for the surface based on a second polarimetric image of the surface;
determine, based on the baseline polarization data and the second polarization data, that there is a wet area on the surface; and
upon determining the wet area, actuate an actuator to cause a clean the surface.

2. The system of claim 1, wherein (i) the baseline polarization includes a baseline degree of polarization and a baseline angle of polarization, and (ii) the second polarization includes a second degree of polarization and a second angle of polarization.

3. The system of claim 1, wherein the instructions further include instructions to identify the wet area as an area for which a change of angle of polarization for a plurality of pixels exceeds an angle threshold.

4. The system of claim 3, wherein the instructions further include instructions to identify the wet area further as an area for which a degree of polarization exceeds a degree of polarization threshold.

5. The system of claim 1, wherein the instructions further include instructions to:
determine the baseline polarization of a plurality of pixels of the first polarimetric image; and
determine the second polarization for a plurality of pixels of the second polarimetric image.

6. The system of claim 1, wherein the material is in a vehicle interior, and the instructions further include instructions to capture the first polarimetric image upon determining, based on received sensor data, that a light intensity in the vehicle interior exceeds a threshold.

7. The system of claim 6, wherein the instructions further include instructions to actuate a light in the vehicle interior upon determining that the light intensity in the vehicle interior is less than the threshold, and capture the first polarimetric image after actuation of the interior light.

8. The system of claim 1, wherein the material is on a vehicle seat, and the instructions further include instructions to capture the second polarimetric image upon determining based at least in part on vehicle door sensor data that the vehicle seat is unoccupied.

9. The system of claim 1, wherein the instructions further include instructions to determine a type of the material of a vehicle seat upholstery and to identify the presumed wet area further based on the determined material.

10. The system of claim 9, wherein the material is on a vehicle seat, and the instructions further include instructions to:
estimate a first threshold for a rate of change of a degree of polarization from a time of a spill and a second threshold for a rate of change of an angle of polarization, based on the determined material of the seat;
capture a plurality of second polarimetric images upon determining that the vehicle seat is unoccupied;
determine the rate of change of the degree of polarization and the rate of change of the angle of polarization based on the captured plurality of second polarimetric images; and
identify the wet area further based on (i) the determined rate of change of the degree of polarization, (ii) the determined rate of change of the angle of polarization, (iii) the first threshold, and (iv) the second threshold.

11. The system of claim 9, wherein the instructions further include instructions to determine the type of the material based on an output of a trained neural network.

12. The system of claim 1, wherein the material is on a vehicle seat, and the instructions to actuate the actuator includes an instruction to actuate a seat heater, output a warning, or navigate the vehicle to a specified location for service.

13. The system of claim 1, wherein the instructions further include instructions to, upon determining that the surface position in the second polarimetric image is changed with respect to the first polarimetric image, adjust the second polarimetric image using a template matching technique.

14. The system of claim 13, wherein the material is on a vehicle seat, and the instructions further include instructions to detect a change in a position of the seat, adjust the second polarimetric image based on the detected change in the position of the seat, and determine whether the seat is wet based at least in part on the adjusted second polarimetric image.

15. The system of claim 1, wherein the instructions further include instruction to actuate a second actuator to restrict an access to the surface upon determining the wet area.

16. A method, comprising:
determining a baseline polarization for a surface of a material based on a first polarimetric image of the surface;
determining a second polarization for the surface based on a second polarimetric image of the surface;
determining, based on the baseline polarization data and the second polarization data, that there is a wet area on the surface; and
upon determining the wet area, actuating an actuator to cause a clean the surface.

17. The method of claim 16, wherein (i) the baseline polarization includes a baseline degree of polarization and a baseline angle of polarization, and (ii) the second polarization includes a second degree of polarization and a second angle of polarization.

18. The method of claim 16, further comprising identifying the wet area as (i) an area for which a change of angle of polarization for a plurality of pixels exceeds an angle threshold or (ii) an area for which a degree of polarization exceeds a degree of polarization threshold.

19. The method of claim 16, further comprising:
determining the baseline polarization of a plurality of pixels of the first polarimetric image; and
determining the second polarization for a plurality of pixels of the second polarimetric image.

20. The method of claim 16, further comprising:
determining a type of the material of a vehicle seat upholstery and to identify the presumed wet area further based on the determined material;
estimating a first threshold for a rate of change of a degree of polarization from a time of a spill and a second threshold for a rate of change of an angle of polarization, based on the determined material of the seat;
capturing a plurality of second polarimetric images upon determining that the vehicle seat is unoccupied;
determining the rate of change of the degree of polarization and the rate of change of the angle of polarization based on the captured plurality of second polarimetric images; and
identifying the wet area further based on (i) the determined rate of change of the degree of polarization, (ii) the determined rate of change of the angle of polarization, (iii) the first threshold, and (iv) the second threshold.
